(19) United States
(12) Patent Application Publication
(10) Pub. No.: US 2007/0180210 A1
(43) Pub. Date: Aug. 2, 2007

(54) Storage device for providing flexible protected access for security applications

(75) Inventor: Robert Harwell Thibadeau, Pittsburgh, PA (US)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/343,337

(22) Filed: Jan. 31, 2006

(51) Int. Cl. G06F 12/14

(52) U.S. Cl. 711/163

(57) ABSTRACT

A data storage apparatus comprising a storage medium having a plurality of physical memory locations referenced through logical block addresses, and a secure partition having a table including at least one range of logical block addresses and identifying one or more functions that can be applied to the logical block addresses by an authorized entity. A method of access control performed by the apparatus is also included.

### FIELD OF THE INVENTION

This invention relates to data storage devices, and more particularly to data storage devices that utilize block data storage.

### BACKGROUND OF THE INVENTION

Block data storage devices store and/or retrieve digital data in the form of blocks, which are individually addressable by a host device. Exemplary block data storage devices include hard disc drives, optical disc recorders and players, and magnetic digital tape recorders and players.

Such devices typically include a hardware/firmware based interface circuit having a buffer (first memory location), a communication channel and a recordable medium (second memory location). The user memory space of the second memory location is divided into a number of addressable blocks, which are assigned host-level addresses (sometimes referred to as logical block addresses or LBAs). Each LBA typically has a corresponding physical block address (PBA) used by servo control circuitry to align a data transducing head with the appropriate portion of a storage medium to access the desired LBA.

To write data to the medium, the host device issues a write command comprising the user data to be stored by the storage device along with a list of LBAs to which the user data are to be stored. The storage device temporarily stores the user data in the first memory location, schedules movement of the data transducing head to the appropriate location(s) over the medium, and then uses write channel portions of the communication channel to apply the appropriate encoding and conditioning of the data to write the data to the selected LBAs.

To subsequently read the data from the storage device, the host device issues a read command identifying the LBAs from which data are to be retrieved. The storage device schedules movement of the data transducing head to the appropriate location(s) over the medium, and then uses read channel portions of the communication channel to decode readback data which are placed into the first memory location (buffer) for subsequent transfer back to the host device.

Modem storage devices are typically read or written using ATA or SCSI commands, and systems that use these storage devices are optimized to employ these commands. Disc drive storage devices can include hidden areas, or protected space, on the disc. Controlled access objects in the hidden areas may provide disc drive embedded processor functions such as drive locking or drive encryption. Controlled access objects in hidden areas are described in U.S. Pat Publication No. 2003/0023867 A1, the disclosure of which is hereby incorporated by reference.

A limitation of the use of the protected space is that normal ATA and SCSI commands cannot be employed for reading and writing data to be protected. While this is highly desirable for certain types of data, such as cryptographic keys, it is not as desirable for other types of data such as user data where the user may desire the data to be seen as normal operating system files once access is granted. Furthermore, modem main platform processors are anticipating the use of protected execution spaces. Each protected execution process may need protected non-volatile storage and may have different demands on this storage at different times. A Hypervisor process can be used to manage these protected execution processes. The Hypervisor should be able to allocate such protected storage within the file system that may be under the direction of the Hypervisor by using different processes. Furthermore, it is desirable that the protected execution processes need not be written or rewritten using specialized ATA or SCSI commands, so that the system would only have to support normal ATA or SCSI commands.

It is also desirable to provide versatile access control over hidden areas of the storage medium. Previous attempts to provide hidden space that can be treated through normal commands have typically remapped the LBA space to different physical space. This has been done both for flash storage devices and disc storage devices. In the disc drive case, the disc drive normally presents a linear LBA space from 0 to N, but if provided with a proprietary command and passcode to change the mapping, will present a 0 to M space with the same “drive letter” but mapped to different physical addresses. An advantage of that technique is that a password protects data from being read or written. A disadvantage is that this remapped drive cannot be the boot drive for the platform, since the system state is lost in switching to different physical data for the drive.

The protected execution space platforms being developed by most major platform processor companies will utilize multiple protected regions. It would be desirable to provide a system for storing protected data in more than one protected region. It would also be desirable to provide the protected data on a boot drive.

### SUMMARY OF THE INVENTION

This invention provides a data storage apparatus comprising a storage medium having a plurality of physical memory locations referenced through logical block addresses, and a secure partition having a table including at least one range of logical block addresses and identifying one or more functions that can be applied to the logical block addresses by an authorized entity.

The invention also encompasses a method comprising: providing a storage medium having a plurality of physical memory locations referenced through logical block addresses, and controlling access to the storage medium using a secure partition having a table including at least one range of logical block addresses and identifying one or more functions that can be applied to the logical block addresses by an authorized entity.

### BRIEF DESCRIPTION OF THE DRAWINGS

FIG. 1 is an isometric view of a disc drive in which the present invention can be used.

FIG. 2 is a schematic representation of a data storage disc.

FIG. 3 is a simplified block diagram of a system that can include the present invention.

FIG. 4 is a flow diagram of an example user authorization procedure.

### DETAILED DESCRIPTION OF THE INVENTION

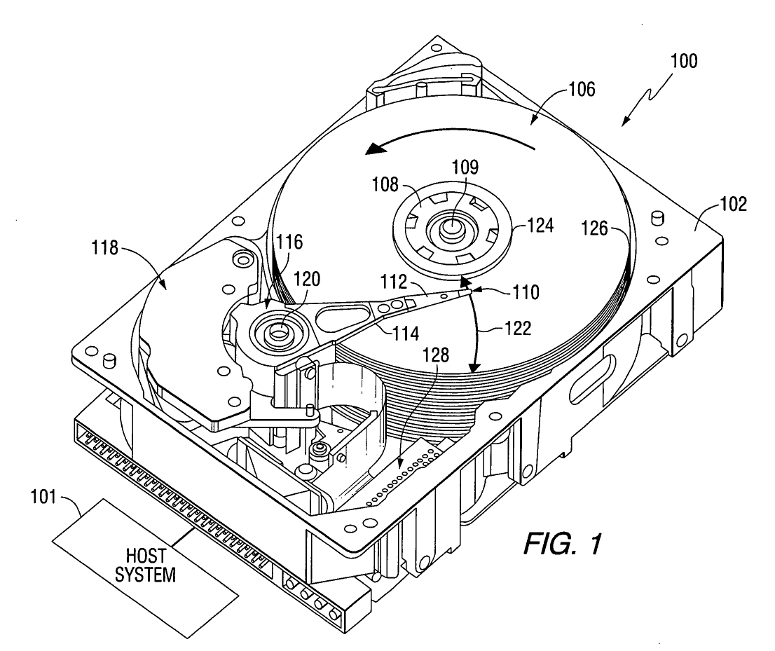

FIG. 1 is an isometric view of a disc drive 100 in which the present invention may be used. Disc drive 100 can be configured as a traditional magnetic disc drive, a magneto-optical disc drive or an optical disc drive, for example. Disc drive 100 is connected to a host system 101, and includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated slider 110, which is mounted to disc drive 100 and carries a read/write head for communication with the disc surface.

In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached sliders 110 about a pivot shaft 120 to position sliders 110 over a desired data track along a path 122 between a disc inner diameter 124 and a disc outer diameter 126. Voice coil motor 118 operates under control of internal circuitry 128. Other types of actuators can also be used, such as linear actuators.

Hereinafter, the terms “storage device” and “disc drive” are used interchangeably, except where otherwise noted, and include any data storage device that is accessible directly via a network or that is installed within or connected to a computer system. The storage device need not necessarily incorporate a physical “disc”, but may include a storage medium or storage components managed by a controller with firmware.

As used herein, the phrase “computer system” is used to refer to any device having memory storage. For example, computer systems include, but are not limited to, desktop computer systems, laptop computer systems, networked computer systems, wireless systems such as cellular phones and PDA's, digital cameras including self-contained web-cams, and/or any reasonable combination of these systems and devices.

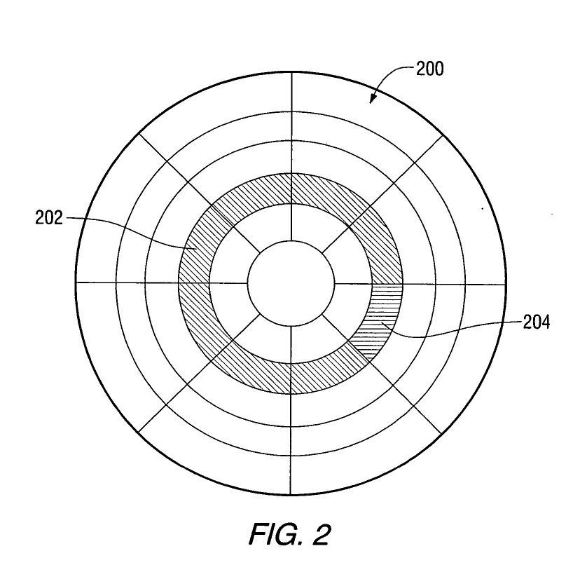

Referring now to FIG. 2, a disc surface 200 of a typical disc (such as a disc of disc pack 106 of FIG. 1) is shown. Each disc surface includes a plurality of concentric tracks to aid in location and readback of data. Each track (such as 202) is further broken down into a plurality of sectors (or physical memory locations), which further aid in location of a particular unit of information. In FIG. 2, portion 204 represents a single sector. These sectors are addressed using a logical block address (LBA) linear addressing scheme. For example, in a 540 Meg drive, LBA 0 corresponds to sector 1 (the first sector) of head 0 (the first head), cylinder or track 0 (the first cylinder 913295 or track), and successively proceeds to the last physical sector on the drive which would be LBA 1,065,456. As used herein, logical block addressing represents any linear addressing scheme.

Disc drive 100 can be a component of a computer system and is utilized to store vast amounts of information relating to operating systems, applications, and user data. Current schemes for the prevention of unauthorized access of user data are primarily implemented in the host computer, with the disc drive having little or no control over the operation of these schemes.

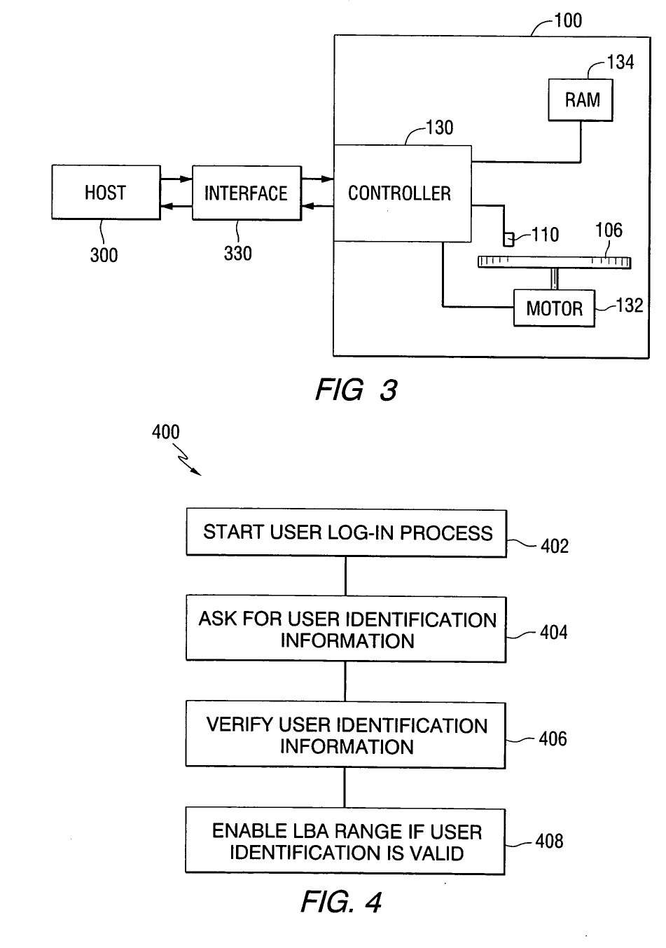

The present invention is described below in connection with FIG. 3 which is a block diagram showing a disc drive 100 constructed in accordance with an embodiment of the present invention coupled to a host computer 300. For a better understanding of the present invention, an environment in which disc drive 100 of the present invention is useful is first described below. Thereafter, details of the present invention are provided.

In FIG. 3, disc drive 100 is coupled to host computer 300, which may be for example, a general-purpose computing device. Components of computer 300 may include a processing unit, a system memory, and a system bus that couples various system components including the system memory to the processing unit. The system bus may be any of several types of bus structures including a memory bus or memory controller, a peripheral bus, and a local bus using any of a variety of bus architectures.

A user may enter commands and information into computer 300 through input devices such as a keyboard and a pointing device, such as a mouse, trackball or touch pad. These and other input devices are often connected to the processing unit through a user input interface that is coupled to the system bus. A monitor or other type of display device is also connected to system bus via an interface, such as a video interface. Computer 300 may operate in a networked environment using logical connections to one or more remote computers, such as a remote computer on which remote application programs reside.

As can be seen in FIG. 3, disc drive 100 is coupled to computer 300 via host-disc interface 330. Computer 300 transfers data to and reads data from disc drive 100 via host-disc interface 330. Host-disc interface 330 may be any type of data exchange interface for coupling a storage device to a host computer, such as SCSI (Small Computer System Interface), UDMA (Ultra Direct Memory Access), ATA (Advance Technology Attachment), or other standards as are known in the industry or are developed in the future.

In disc drive 100, data is received from, or provided to, host computer 300 using an embedded controller 130. In general, controller 130 carries out its functions by executing instructions contained in memory 134.

Disc drive 100 provides storage of computer readable instructions, data structures, program modules and other data for computer 300. In FIG. 3, for example, the disc drive 100 can store an operating system, application programs, other program modules, and program data. Note that these components can either be the same as or different from the operating system, application programs, other program modules, and program data stored in the host.

In the disc drive, the operating system, application programs, other program modules, and program data are stored as files, with each file being stored over a cluster of sectors (or physical memory locations) referenced through LBAs. In general, the disc drive controller operates independently of the host operating system and is therefore unaware of any LBA-file relationships. In other words, if the host computer sends data corresponding to a file to the disc drive, the information reaches the disc controller as data to be stored in an LBA range. In response to receiving the data storage information, the controller simply transmits the data to the head 110 to store the data in physical memory locations that correspond to the specified contiguous LBA range.

In accordance with one embodiment of the present invention, program instructions for an LBA range and other corresponding functions, which controller 130 is capable of executing, are stored in memory 134. In addition, a table that can store at least one predetermined range of LBAs, which correspond to at least a subset (less than all) of the plurality of physical memory locations, is included in a secure partition of a non-volatile memory (on a disc surface, for example). Table 1 is an example of such a table. The table includes at least one range of logical block addresses and identifies one or more functions that can be applied to the logical block address by an authorized entity.

TABLE 1

| | LBA | LBA | ReadLock | WriteLock | | | Encryption |
|---|---|---|---|---|---|---|---|
| Row # | Start | Length | Enable | Enable | ReadLock | WriteLock | Key |
| 1 | 0 | 0 | ON/OFF | ON/OFF | ON/OFF | ON/OFF | <key 1> |
| 2 | 1000 | 5000 | OFF | ON | ON/OFF | ON | <key 2> |
| 3 | . . . | | | | | | |
| 4 | . . . | | | | | | |

In Table 1, Row 1 is special and refers to the entire LBA range of the storage device. The other rows, such as Row 2, contain subranges of the LBAs, which are to be treated differently. In this example, Row 2 specifies that WriteLocking is enabled, meaning that the condition of the WriteLock column determines whether the 5,000 blocks following LBA 1,000 can be written. In this case, WriteLock is Enabled and WriteLock is ON and this range cannot be written. ReadLock is disabled, so the ReadLock value is irrelevant and Read is Unlocked. The purpose of the two Booleans (one that Enables and the other that effects the locking or not) is that there are three states captured. The Enable flag indicates whether the Locking flag is relevant or not, and if it is relevant, then the two states of Lock and Unlock are controlled by the Locking flag. In effect, the authority that can enable locking can be different than the authority that can unlock or lock the region for reading or writing. Notice also that this table can contain an encryption key whose presence encrypts data written to the media and decrypts data read from the media.

The table is stored in a secure partition in non-volatile memory. Secure partitions are described in U.S. patent application Ser. No. 09/912,931 (Publication No. 2003/0023867 A1), the disclosure of which is hereby incorporated by reference. In general, a secure partition is a region of storage on the disc. The LBA table can, in fact, be in an LBA range called out in the table or may be in another area of storage that is not in any of the LBA ranges identified in the table including entire LBA range covered by Row 1 of the table.

Such an LBA table can be created at the time of disc manufacture. Records can be added to the table and/or modified after the disc drive is installed in the host computer. Additions, deletions and updates of records in the table(s) can be carried out by utilizing suitable commands that are compatible with host-disc interface protocols and security authorizations. Usually, the LBA ranges are assigned to coincide with disc partitions.

In response to receiving the data storage information, the controller stores the data in physical memory locations that correspond to the specified LBA range. However, in accordance with the present invention, prior to storing or retrieving the data in the corresponding physical memory locations, controller 130 determines whether the user is authorized to access the specified LBA range. Thus, the present invention provides a substantially host-independent and file-independent access scheme.

The user authorization process is carried out to determine whether or not functions for any predetermined range(s) of LBAs are enabled for a current user of the host computer. User authorization is preferably carried out at the time the user logs in to the host computer.

FIG. 4 is a flow chart 400 of an example authorization procedure in accordance with an embodiment of the present invention. Authorization provides the capability of writing or reading values in the table. The authorization method, and which authority can read and write which cells in the table, can be set when configuring the storage device for a particular purpose. So, for example, an administrator authorization may be able to set the value of whether a particular LBA range can be ReadLock or WriteLock Enabled, while a user or computer authorization may be able to set the ReadLock or WriteLock value.

In accordance with the procedure for a user authorization, a user log-in process begins at step 402. At step 404, the user is asked to enter identification information (username and password, for example). At step 406, the user identification information is verified. At step 408, access is enabled if the user identification information is found to be valid.

In some embodiments of the present invention, the identification information includes a cryptographic key and a proof of knowledge of that key's value. Authorization information may be stored in, or tied (joined) to, the range table. The authorization procedure can be implemented in the storage device. In some embodiments, some parts of the authorization procedure are implemented in the operating system. In other embodiments, some parts of the authorization procedure may be implemented in BIOS or in a BIOS extension. It should be noted that no operating system changes are required when the user authorization is implemented in the BIOS or BIOS extension. The user authorization scheme can also employ security tokens, biometric scanners, etc., which enhance the security of authorization beyond more basic pass phrases. The particular authorization required to change a value in the range table would be under the control of the agent setting up the access controls.

The contents of the range table can be modified (records can be added, deleted and/or updated) by utilizing commands that are compatible with host-disc interface protocols. An authorization process can be carried out to determine a level of access (no access, query only, or query and update) that a current user of the host computer has to the LBA range table(s). The user authorization process may be carried out using techniques similar to those described above. User authorization information may be stored in a hidden area of the disc drive and may be loaded into the host computer during the authorization process.

The present invention can be implemented using a logical block address mapping (LBAM) security partition (SP) that is specialized as an LBAM SP. The LBAM SP can be issued to a single authority in the host under strict versatile access control. In secure execution processors, this may be the local Hypervisor process. The drive manufacturer can provide a table in the LBAM SP that protects the LBA addresses for the LBAM SP and other SPs. This prevents normal read/write operations over those spaces, but applications can be written that use the manufacturer authority to change the size of the SP protected space.

The LBAM mapping can be a generalization of the mapping of a second partition to an LBA range, beginning with LBA 0. In this case, the range table would be further modified to control this mapping as shown in Table 2. This table includes an additional column, “LBA Mapped Start”. As in Table 1, row 1 applies to all LBAs in the storage device. Row 2 shows that the LBAs from 1000 to 6000 (1000+5000) are mapped down to LBA 0 to 5000 for Reading and/or Writing if ReadLock and/or WriteLock is enabled and the ReadLock is OFF (released) and/or the WriteLock is OFF. If a row is remapped, then it replaces the address range it is remapped over. In the case illustrated for Table 2, the entire LBA range is decreased by 1000 blocks because the range 1000-6000 is remapped down to 0-5000. In one embodiment, the storage system firmware must check and disallow configurations where the interpretation is indefinite or ambiguous or exceeds the capacity of firmware and circuits to perform the remapping.

TABLE 2

| | | | LBA | | | | | |
|---|---|---|---|---|---|---|---|---|
| | LBA | LBA | Mapped | ReadLock | WriteLock | | | Encryption |
| Row # | Start | Length | Start | Enable | Enable | ReadLock | WriteLock | Key |
| 1 | −1 | −1 | −1 | ON/OFF | ON/OFF | ON/OFF | ON/OFF | <key 1> |
| 2 | 1000 | 5000 | 0 | OFF | ON | ON/OFF | ON | <key 2> |
| 3 | . . . | | | | | | | |
| 4 | . . . | | | | | | | |

By remapping the LBA start, the LBA ranges can be completely hidden from the user. This permits secure partitions wherein one such partition could hold the table itself and be permanently Locked from conventional reading or writing except through the authorization controls. This would have the advantage that a secure partition for storage of the table and authorization data could be configurable in size within the raw LBA space.

It should be apparent that an alternative embodiment may combine ReadLock and WriteLock into a single Read/WriteLock.

With this invention, the software only sees itself and other things that it is permitted to see. A Hypervisor can be used to allocate secure execution environments. The invention can provide a protected space for a Hypervisor. A key to a protected area can be provided by a Hypervisor.

Without a Hypervisor, a technical security problem remains that malicious ATA or SCSI read/write commands may be executed once an authority is recognized. The process would authenticate the authority to the LBA range, and then read or write, and finally remove the authorization. If another process can recognize that an authority has been established on a particular LBA range, then the other process could write that LBA range.

There are a number of different approaches to providing assurance that only the correct standard read/write commands can read or write the protected LBA range(s) defined in the tables. In one approach, the read/write commands may occur in a secure session established by the drive that is initiated by the LBAM authorization. Thus the process that is issuing the read/write commands cannot be observed by the other process as to what LBA addresses are being read or written. Since the read/writes are tunneled inside a secure messaging layer, every read or write is properly authenticated. The secure session insures that the reads and writes cannot be observed by the other process and cannot be impersonated by the other process.

In another approach, the data read or written can be required to contain an authenticating code established by the secure session; for example, by using a keyed hash.

In a third approach, the LBAM tables can be enhanced to provide versatile security control over the normal read/write commands. For example, the LBAM entry could also specify the number and hash value of the data payload, thereby bypassing a need to encrypt all the data sent or received, or having to reformat the data in the read/write payloads. In this way, read/write commands to different LBA ranges can be interspersed without losing the session identity for the data. Presumably, however, this would also require invoking a transactional commit mechanism that would require a copy of the data to be made in writing until a commit (hash checked session end) is made.

Alternatively, in some processing environments, the read/write channel itself may be secured to the specific secure process(es), in which case the session itself lasts as long as the read/write channel (which could be protected by hardware indefinitely). In this case the set up of the LBAM is the equivalent of an exclusive enrollment process and hash methods and secure messaging methods need not be employed except in establishing the enrollment itself. It is anticipated that the Hypervisor may use a region that is protected by exclusive hardware of this kind.

Finally, an LBAM table could be further enhanced to incorporate an encryption key, or indirect reference to an encryption key, that would cause all the data in the LBA range to be encrypted onto the media and decrypted off of the media. This would be a natural enhancement to whole drive encryption and would provide greater flexibility while retaining the convenience and portability of whole drive encryption. In addition, the LBAM encrypting ranges can encrypt on top of default whole drive encryption if circuits permit this. In this case the LBAM SP would be associated with one or more encrypting drive SPs that contain the other tables needed to manage encrypting keys.

The Operating System, or more specifically the file system vendor with proper cryptographically controlled authorization, can create protected spaces suitable for normal OS/file system use without having to change normal read/write operations (although initialization and later storage recovery would have to be added to the host OS/file system or an application, such as a Hypervisor, running in a secure execution space processor and host OS). The user simply runs processes that he knows can read and write protected storage areas not accessible to other processes running on the same machine. The Hypervisor provides the user with assurance that his areas are not accessible by other processes.

This invention allows booting from the drive because the LBA to physical space mapping never changes. The notion of providing LBA ranges that are frozen in one way or another is well-known. However, this invention provides a uniform tabular interface to LBA mapping, Read/Write Locking, and Encryption that also permits secure versatile security management after the storage device interface, in the embedded controller of the storage device.

The present invention substantially improves on prior approaches by associating programmable and versatile access control over LBA ranges and providing for LBA range protection, LBA remapping, separable read and write control over LBA ranges, and LBA range encryption in a single, modular mechanism. The mechanism is modular because any subset of these features may be combined within the present invention.

This invention provides a versatile access control system for restricting access to LBA ranges. Such a system enables a selection among authorization methods that can include password authorization and various cryptographic authorization methods. The system also permits authorizations to be combined as Boolean combinations for tests of authorization. One example is a cross certification, where two authorizations are required to gain LBA access, activate LBA remapping, or to change the authorization rules.

The invention allows remapping of LBA ranges for multiple virtual drives. Access control is placed on the LBA ranges. Virtual access control can be provided using passwords, keys, etc. The operating system protects the LBA ranges by applying access control. Multiple master boot records are allowed.

The invention can further provide an access control system for restricting access to LBA ranges that can be securely tied to modern high security host systems. A single apparatus can be used for read/write locking, LBA access control, LBA mapping, and read/write encryption of LBA ranges.

In various embodiments, a single apparatus can be used for read/write locking and read/write encryption of LBA ranges; for read/write locking and LBA remapping; or for LBA remapping and read/write encryption of LBA ranges.

While the invention has been described in terms of several examples, it will be apparent to those skilled in the art that various changes can be made to the described examples without departing from the scope of the invention as set forth in the following claims.

What is claimed is:

1. A data storage apparatus comprising:
a storage medium having a plurality of physical memory locations referenced through logical block addresses; and
a secure partition having a table including at least one range of logical block addresses and identifying one or more fictions that can be applied to the logical block addresses by an authorized entity.

2. The apparatus of claim 1, wherein the table includes a first set of entries applicable to a plurality of the logical block addresses and a second set of entries applicable to a subset of the plurality of the logical block addresses.

3. The apparatus of claim 1, wherein:
the table includes a WriteLock Enable entry and a WriteLock entry, wherein the WriteLock Enable entry determines the relevance of the WriteLock entry; and
the table includes a ReadLock Enable entry and a ReadLock entry, wherein the ReadLock Enable entry determines the relevance of the ReadLock entry.

4. The apparatus of claim 1, wherein the table includes an encryption key for encrypting data written to and/or read from the range of logical block addresses.

5. The apparatus of claim 1, further comprising:
a secure read/write channel for reading and/or writing data to the storage medium.

6. The apparatus of claim 1, wherein the table includes information controlling one or more of:
read/write locking of the logical block address ranges; and
read/write encryption of the logical block address ranges.

7. The apparatus of claim 1, wherein the table includes information controlling remapping of the logical block address ranges.

8. The apparatus of claim 1, wherein the secure partition includes authorization data.

9. A method comprising:
providing a storage medium having a plurality of physical memory locations referenced through logical block addresses; and
controlling access to the storage medium using a secure partition having a table including at least one range of logical block addresses and identifying one or more functions that can be applied to the logical block addresses by an authorized entity.

10. The method of claim 9, wherein the table includes a first set of entries applicable to a plurality of the logical block addresses and a second set of entries applicable to a subset of the plurality of the logical block addresses.

11. The method of claim 9, wherein:
the table includes a WriteLock Enable entry and a WriteLock entry, wherein the WriteLock Enable entry determines the relevance of the WriteLock entry; and
the table includes a ReadLock Enable entry and a ReadLock entry, wherein the ReadLock Enable entry determines the relevance of the ReadLock entry.

12. The method of claim 9, wherein the table includes information controlling one or more of:
read/write locking of the logical block address ranges; and
read/write encryption of the logical block address ranges.

13. The method of claim 9, wherein the table includes information controlling remapping of the logical block address ranges.

14. The method of claim 9, wherein the table includes an encryption key for encrypting data written to and/or read from the range of logical block addresses.

15. The method of claim 14, wherein data to be read or written includes an authenticating code.

16. The method of claim 9, further comprising:
issuing read and/or write commands in a secure session that is authorized in accordance with the table.

17. The method of claim 9, wherein reading or writing the table values requires authorization information.

18. The method of claim 9, wherein the secure partition includes authorization data.
